(19) United States
(12) Patent Application Publication
(10) Pub. No.: US 2009/0207348 A1
(43) Pub. Date: Aug. 20, 2009

(54) OPTICAL DISPLAY DEVICE AND MANUFACTURING PROCESS FOR THE SAME

(75) Inventor: Yoshiaki HASHIMOTO, Kanagawa (JP)

Correspondence Address: YOUNG & THOMPSON, 209 Madison Street, Suite 500, ALEXANDRIA, VA, 22314, US

(73) Assignee: NEC LCD TECHNOLOGIES, LTD., KANAGAWA (JP)

(21) Appl. No.: 12/361,589

(22) Filed: Jan. 29, 2009

(30) Foreign Application Priority Data
Feb. 14, 2008 (JP) 2008-33691

(51) Int. Cl. G02F 1/1335

(52) U.S. Cl. 349/96; 445/24

(57) ABSTRACT

An optical display device of the invention includes an optical display panel, an optical film arranged so that at least one side of a surface on the optical display panel can be covered, and an adhesive layer for fixing the optical film on the optical display panel, wherein the adhesive layer is arranged outside a transparent substrate constituting the optical display panel as seen from a normal direction to a display surface of the optical display panel, and there is no gas layer between said optical film and the display area on the optical display panel.

### INCORPORATION BY REFERENCE

This application is based upon and claims the benefit of priority from Japanese Patent Application No. 2008-033691, filed on Feb. 14, 2008, the disclosure of which is incorporated he rein in its entirety by reference

### BACKGROUND OF THE INVENTION

1. Technical Field

The present invention relates to an optical display device and a manufacturing process for the same, and in particular, relates to a liquid crystal display (LCD) device and a manufacturing process for the same.

2. Background Art

An LCD panel which is a representative of optical display devices is generally provided with a TFT substrate, a counter substrate, a liquid crystal material inserted between the TFT substrate and the counter substrate, a sealing material for sealing the liquid crystal material between a pair of the substrates, and polarizing plates arranged so that the surfaces of the TFT substrate and the counter substrate can be covered.

Each of the polarizing plates is generally made by sandwiching a polarizer, which is formed by dyeing an extended polyvinyl alcohol (PVA) film with iodine, with triacetate cellulose (TAC) films.

Each of the polarizing plate is uniformly adhered to entire outside surfaces of the substrates of the LCD panel by using an adhesive layer, respectively.

In the manufacturing process of the LCD panel, a reworking process of the polarizing plate is performed in the cases where a foreign object is mixed into the interface between the substrate and the polarizing plate, defect in a sticking position of the polarizing plate occurs, or the polarizing plate has some trouble. When the polarizing plate is removed in the reworking process, the substrate is largely deformed because stress is added to the substrate through the adhesive layer formed on entire surface of the polarizing plate. Then, migration or plastic deformation of a spacer material supporting a cell gap is generated, and gap unevenness arises.

An example of a related LCD device for solving such a problem is described in Japanese Patent Application Laid-Open No. Hei 11-119212. This related LCD device is provided with a first substrate, a second substrate, a liquid crystal composition inserted between the first substrate and the second substrate, a first polarizing plate adhered to the first substrate, and a second polarizing plate adhered to the second substrate. Here, it is described that the gap unevenness can be suppressed by means of limiting the adhesive strength of the adhesive layers to less than 1000 g/20 mm which adheres the first polarizing plate to the first substrate or adheres the second polarizing plate to the second substrate, respectively.

In Japanese Patent Application Laid-Open No. Hei 10-44291, a disclosed structure has an adhesive layer provided on one side or both sides of an optical film. The adhesive layer include s a polymer base material of an acrylic system polymer with a functional group concentration of 5×1/10⁴ mol/g or less and having 600 g/20 mm or less in 90-degree peeling adhesive strength.

In Laid-open Japanese utility model publication No. Sho 60-054121, a structure is disclosed in which an LCD panel is bonded to a polarizing plate with an adhesive member of a framed shape in order to prevent display quality from deteriorating because of voids generating in an adhesive layer which bonds a polarizing plate to an LCD panel.

### SUMMARY

An exemplary object of the invention is to provide an optical display device which can prevent defects such as gap unevenness or a break in the substrate regardless of substrate thickness or panel size in reworking a polarizing plate.

The optical display device according to an exemplary aspect of the invention includes an optical display panel, an optical film arranged so that at least one side of a surface on the optical display panel can be covered, and an adhesive layer for fixing the optical film on the optical display panel, wherein the adhesive layer is arranged outside a transparent substrate constituting the, optical display panel as seen from a normal direction to a display surface of the optical display panel, and there is no gas layer between said optical film and the display area on the optical display panel.

A manufacturing process of an optical display device according to an exemplary aspect of the invention includes forming an optical display panel having a display area on a transparent substrate, arranging an optical film so that said optical display panel may be covered, arranging an adhesive layer on the optical film outside of the transparent substrate as seen from a normal direction to a display surface of the optical display panel, and sticking the optical film on the optical display panel by the adhesive layer without mixing a gas layer therebetween with allover surface of the display area closely adhering.

### BRIEF DESCRIPTION OF THE DRAWINGS

Exemplary features and advantages of the present invention will become apparent from the following detailed description when taken with the accompanying drawings in which:

FIG. 1 is a plan view showing a structure of an LCD device according to a first example of the present invention;

FIG. 2A is a cross-sectional view along a II-II line of FIG. 1;

FIG. 2B and FIG. 2C are enlarged views of a part of FIG. 2A;

FIG. 3 is a plan view showing a structure of an LCD device according to a second example of the present invention;

FIG. 4 is a cross-sectional view along a IV-IV line of FIG. 3;

FIG. 5 is a plan view showing a structure of an LCD device according to a third example of the present invention;

FIG. 6 is a cross-sectional view along a VI-VI line of FIG. 5;

FIG. 7 is a characteristic diagram showing measured results of deformation per unit load in a related LCD panel; and.

FIG. 8 is a characteristic diagram showing measured results of breaking load in a related LCD panel.

### EXEMPLARY EMBODIMENT

Examples of the present invention will now be described in detail in accordance with the accompanying drawings.

### A FIRST EXAMPLE

An LCD panel as an optical display device according to a first example of the present invention has a TFT substrate, a counter substrate, a liquid crystal material inserted between the TFT substrate and the counter substrate, a sealing material to seal the liquid crystal material between the TFT substrate and the counter substrate, polarizing plates arranged so that the surface of the TFT substrate and the counter substrate can be covered, and adhesive layers for fixing the polarizing plates on the TFT substrate and the counter substrate respectively. And the adhesive layer is only formed on the outer peripheral part of the LCD panel and is not formed on a part of a display area including the polarizing plate.

By adopting the above structure, adhesive strength between the polarizing plate and the substrate can be made smaller, and thus gap unevenness and a break in the substrate in reworking a polarizing plate can be prevented.

In addition to the above-mentioned structure, the LCD panel has a structure in which the polarizing plate is firmly stuck on the display surface, or a structure in which a fluid substance is applied to the interface between the polarizing plate and the display surface. Because an air gap is not generated between the polarizing plate and the substrate according to this structure, even if substrate thickness becomes thinner, gap unevenness and a break in the substrate can be suppressed.

An advantageous effect of this example is described in detail hereinafter. As described in the background art, in the LCD panel formed on the thin substrate, the substrate can be largely deformed by a weak stress when the polarizing plate is removed. As a result, gap unevenness arises because migration or plastic deformation of a spacer material supporting a cell gap is generated. And the substrate itself can be broken when a polarizing plate is removed.

These problems are described more in detail.

First, the gap unevenness in reworking the polarizing plate is described. An amount of the maximum deflection of a glass substrate in a simple beam (δmax) is given by a following Equation (1), where “P” stands for a concentrated load, “a” stands for a span length, “b” stands for a width in the section of the glass substrate, “E” stands for a Young's modulus, and “d” stands for a thickness of the glass substrate.

δmax=(P·a³)/(4·b·E d³) (1)

That is, the amount of deflection in the substrate increases in proportion to the inverse of the third power of the substrate thickness. Therefore, the deformation of the substrate becomes larger as the substrate thickness becomes thinner.

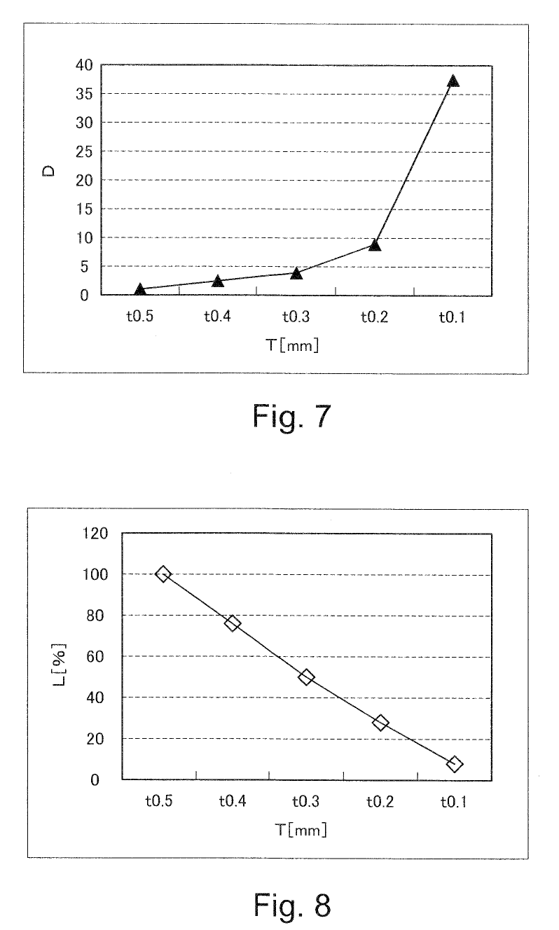

In order to confirm this relation, deformation D per unit load is measured using a related LCD panel. The results are shown in FIG. 7. The substrate thickness T (t0.5/t0.4/t0.3/t0.2/t0.1) in FIG. 7 means the thickness of a piece of glass substrate which constitutes the LCD panel, so the panel thickness is twice (1.0/0.8/0.6/0.4/0.2 mm) as thick as this substrate thickness T. The deformation D in the vertical axis of FIG. 7 shows the value which is gotten by measuring the value of the maximum deflection (δmax) and the load (P) and by being standardized with the value for the panel with the substrate thickness T of t0.5. The polarizing plate having adhesive strength of about 2000 g/20 mm in the adhesive layer is used.

The measurement is performed on the condition that the panel whose size in a diagonal direction is 2.7 inches is supported by two edges in the longitudinal direction, and an edge load parallel to a supporting portion is applied to the central portion of the panel. The loading speed is set at 0.1 mm/sec. The test results in FIG. 7 show that the amount of the substrate deformation becomes larger as the substrate thickness becomes thinner.

Generally, in an LCD device, a TFT substrate and a counter substrate are adhered in a sealant part to seal the liquid crystal cell. Therefore, near the central portion of the liquid crystal cell corresponding to a display area, a distance from the sealant becomes its maximum, and a deformation of the substrate becomes its maximum when removing a polarizing plate. For example, the equation (1) shows that if a diagonal direction size increases to 5 inches, the deformation per unit distance increases by 4.6 times on the basis of the panel whose diagonal direction size is 3 inches, and if -the diagonal direction size increases to 8 inches, the deformation per unit distance increases by 19 times.

That is, in the related liquid crystal display panel, the amount of the substrate deformation becomes larger by the stress when removing a polarizing plate, as the substrate thickness becomes thinner and the panel size becomes larger.

Here, a force is added to a spacer inside the cell because the stress added to the substrate causes the deformation of the substrate. If a spherical spacer is used for supporting a cell gap, this force moves the spacer because the spherical spacer is not firmly adhered to the surface of the substrate. As a result, in the LCD panel with the spherical spacer, the amount of substrate deformation due to the stress in reworking a polarizing plate increases as the substrate thickness becomes thinner and the panel size becomes larger. And the spacer distribution becomes uneven by the migration thereof. Therefore, it is likely that the defect due to gap unevenness arises.

On the other hand, if a columnar spacer is used for supporting a cell gap, the gap defect due to the migration of the spacer does not arise unlike with the spherical spacer because the columnar spacer is firmly adhered to the counter substrate. However, because generally used columnar spacer consists of a photosensitive acrylic system material, its elastic modulus is small as compared with that of the spherical spacer. For this reason, if stress is locally added to some columnar spacers because of a substrate deformation in removing a polarizing plate, plastic deformation of the columnar spacer material arises, and gap unevenness may result from the deformation in that part.

Next, the break in the substrate generated in reworking a polarizing plate is described. A maximum bending stress (σmax) in a glass substrate is given by a following equation (2), where “P” stands for a concentrated load, “a” stands for a span length, “b” stands for a width in the section of the glass substrate, “E” stands for a Young's modulus, and “d” stands for a thickness of the glass substrate.

σmax=(3·P·a)/(b·d²) (2)

The equation (2) shows that the maximum bending stress in a substrate is in inverse proportion to the square of substrate thickness and becomes remarkably larger as the substrate becomes thinner, and consequently it is likely that the break in the substrate is generated.

In order to confirm this relation, a breaking load L is measured using the related LCD panel. The results are shown in FIG. 8. The substrate thickness T (t0.5/t0.4/t0.3/t0.2/t0.1) in FIG. 8 means the thickness of a piece of glass substrate which constitutes the LCD panel, so the panel thickness is twice (1.0/0.8/0.6/0.4/0.2 mm) as thick as this glass substrate thickness T. The breaking load L in the vertical axis of FIG. 8 shows the value which is standardized with the value for the panel with the substrate thickness T of t0.5. The polarizing plate having adhesive strength of about 2000 g/20 mm in the adhesive layer is used.

The measurement is performed on the condition that the panel whose size in a diagonal direction is 2.7 inches is supported by two edges in the longitudinal direction, and an edge load parallel to a supporting portion is applied to the central portion of the panel. The loading speed is set at 0.1 mm/sec. The test results in FIG. 8 also show that the substrate is likely to break more easily as the substrate thickness becomes thinner.

However, in the LCD panel of this example, because the adhesive strength between the polarizing plate and the substrate can be made smaller and an air gap is not generated in the layer between the polarizing plate and the substrate. Therefore, even if the substrate thickness becomes thinner, the gap unevenness and the break in the substrate due to reworking a polarizing plate can be suppressed.

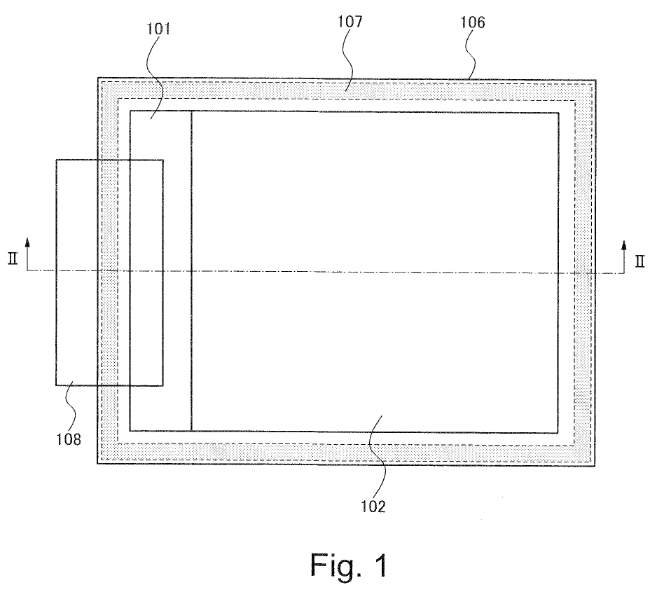

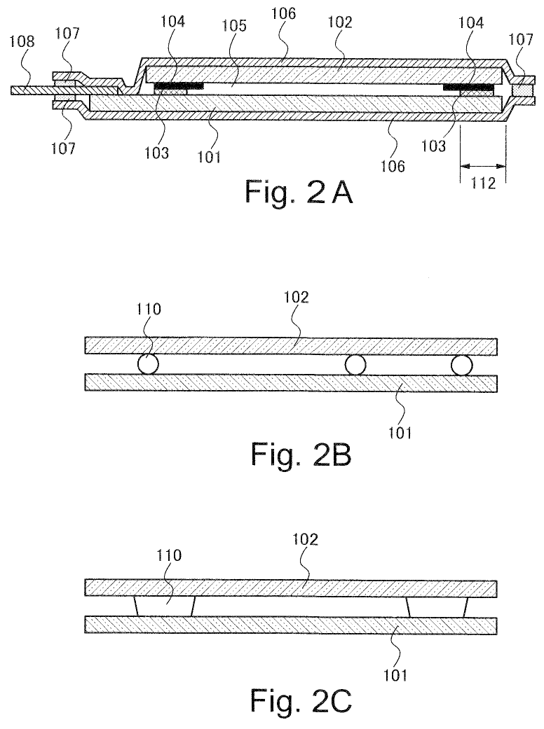

Next, the LCD device according to the first example of the present invention will be described more in detail with reference to FIG. 1 and FIG. 2. FIG. 1 is a plan view showing the structure of the LCD device of this example, FIG. 2A is a cross-sectional view along a II-II line of FIG. 1, and FIG. 2B and FIG. 2C are enlarged views of a part of FIG. 2A, respectively.

As shown in FIG. 1 and FIG. 2, the LCD panel of this example mainly includes a TFT substrate 101, a counter substrate 102, a black matrix in a frame area 104 (called a frame BM 104 from now on) formed so as to enclose the peripheral edge part on the counter substrate 102 side, and a liquid crystal material 105 inserted between the TFT substrate 101 and the counter substrate 102. As shown in FIG. 2B and FIG. 2C, in order to keep a cell gap of the liquid crystal material 105 constant, spacer members 110 are formed between the TFT substrate 101 and the counter substrate 102. A sealant 103 is formed on the region which overlaps with the frame BM 104 in the outside of a display area in order to seal the liquid crystal material 105 between the TFT substrate 101 and the counter substrate 102. Polarizing plates 106 are closely formed so that the surface of the TFT substrate 101 and the counter substrate 102 can be covered, respectively. In order to fix a relative position of these polarizing plates 106 to the TFT substrate 101 and the counter substrate 102, an adhesive layer 107 is formed in a peripheral edge part of the polarizing plate 106 corresponding a surrounding part of the TFT substrate 101 and the counter substrate 102 as seen from a normal direction to the display surface. A flexible wiring substrate 108 is connected to a terminal part in the TFT substrate 101.

As a base material used for the TFT substrate 101 and the counter substrate 102, a glass substrate or a resin film such as polyethylene terephthalate (called PET hereafter) and polyethylene naphthalate (called PEN hereafter) can be used.

The sealant 103 and the resin BM 104 do not necessarily need to be overlapped, but the sealant 103 can be formed in the outside of the resin BM 104. Thus, if the sealant 103 is located in the outside of the resin BM 104, it is possible to radiate the light from the counter substrate 102 side using a photo-cured sealing material.

Here, if a light-and-heat curing type material of an acrylic epoxy system is used for the sealant 103, an adhesive strength of not less than 20000 g/20 mm can be obtained. On the other hand, the adhesive strength of the adhesive layer 107 is determined so that it is smaller than that of the sealant 103 although it has sufficient strength, and the panel can not be separated from the sealant in removing the polarizing plate. Specifically, it is desirable for the adhesive strength of adhesive layer 107 to be in the range of 5000-10000 g/20 mm. An acrylic system material is used as a material of the adhesive Layer 107.

If voids or an air gap remain between the polarizing plate 106 and TFT substrate 101 or the counter substrate 102, reflection or refraction of the light arises in an interface with the air gap because of the difference of a refractive index from the air. As a result, characteristics degradation, such as a brightness increase in a black picture, is caused.

However, in this example, because the display area in the TFT substrate 101 or the counter substrate 102 is closely stuck with polarizing plate 106 covering the face of each substrate, there is no air gap between them. Therefore, excellent properties in the display are obtained.

Next, a manufacturing process of the LCD device of the first example is described. First, after forming the sealant 103 on the peripheral edge part 112 of the TFT substrate 101, the TFT substrate 101 and the counter substrate 102 are stacked each other, and the liquid crystal panel is formed by sealing the liquid crystal material 105 therebetween.

Next, the flexible wiring substrate 108 is mounted on the terminal part of the TFT substrate 101.

Then, adhesive layer 107 which consists of two kind of liquid materials is drawn on the part of the polarizing plate 106 covering the TFT substrate 101 side where the polarizing plate 106 adheres to the flexible wiring substrate 108.

Next, after aligning the liquid crystal panel with the polarizing plate 106 in a predetermined position, they are stacked, and then the flexible wiring substrate 108 and the polarizing plate 106 covering the TFT substrate 101 are adhered by means of the adhesive layer 107.

Then, the adhesive layer 107 is drawn on the peripheral edge part of the polarizing plate 106 covering the counter substrate 102. Next, after aligned the polarizing plate 106 covering the TFT substrate 101 with a predetermined position, they are stuck by using a pressure roller. As a result, the LCD device according to the first example of the present invention is completed.

Here, regarding the direction in sticking, the flexible wiring substrate 108 side is made the starting direction of attachment. Voids and an air gap can be prevented from mixing into the interface between the polarizing plate 106 and the TFT substrate 101 or the counter substrate 102 by sticking extruding air from the end of the substrate.

Although the process for sticking the polarizing plate 106 using the pressure roller is described, it is not limited to this, but a process for sticking in a vacuum, for example, can be used. In this case, after forming adhesive layer 107, by stacking the liquid crystal panel and the polarizing plate 106 in a vacuum and then returning it to the atmospheric pressure, an inside of a region surrounded by the adhesive layer becomes a vacuum, and the whole surface in the display area can be closely stuck.

The polarizing plate 106 consists of a polarizer and a polarizer protective layer at least. It is desirable to adopt a thermoplastic transparent resin with high gas barrier property as the polarizer protective layer or example, a PET, a PEN, or one of those materials with a surface treatment can be used.

If a resin such as thermoplastic PET or PEN is used for adhesion part in which polarizing plates 106 are opposed to each other, the polarizing plates facing each other can be adhered by means of a hot welding or an ultrasonic welding without using adhesives. In this case, if a thermoplastic resin material such as a PET or a PEN is also used for an adhesion part in the flexible substrate, welding process can be simultaneously performed. Therefore, adhesive costs and manufacturing costs can be reduced.

The fluid substance with excellent ageing stability can be applied on the whole surface between the polarizing plate 106 and each substrate surface corresponding to the display area in the TFT substrate 101 or the counter substrate 102. The decrease in the detachability due to fixation of the stuck interface can be prevented by applying the fluid substance to the surface between the substrate and the polarizing plate 106. And the fluid substance is closely stuck on both of the substrate surface and the polarizing plate 106, as a result, it is possible to assist adhesion between the both.

In this case, it is desirable that the fluid substance has a refractive index almost equal to one of the TFT substrate 101 or the counter substrate 102, and is a water-white substance which does not affect optical performance. For example, silicone oil, silicon gel, etc. whose refractive index is adjusted to about 1.4 to 1.6 can be used.

Although the adhesive layer 107 consisting of two kind of liquid adhesives is described, it is not limited to this, an acrylic photo-curing adhesive or a thermosetting adhesive of an epoxy system can be used. Also as for the formation process for the adhesive layer 107, it is not restricted to using a dispensing system and a printing process can be used too. If a photo-curing material is used as the adhesive layer 107, it is possible to make it harden by light irradiation from the direction in a side wall of the liquid crystal panel. And if a thermosetting material is used, a material of an epoxy system can be used which is hardened at the temperature lower than a heat-resistant temperature of the polarizing plate.

### SECOND EXAMPLE

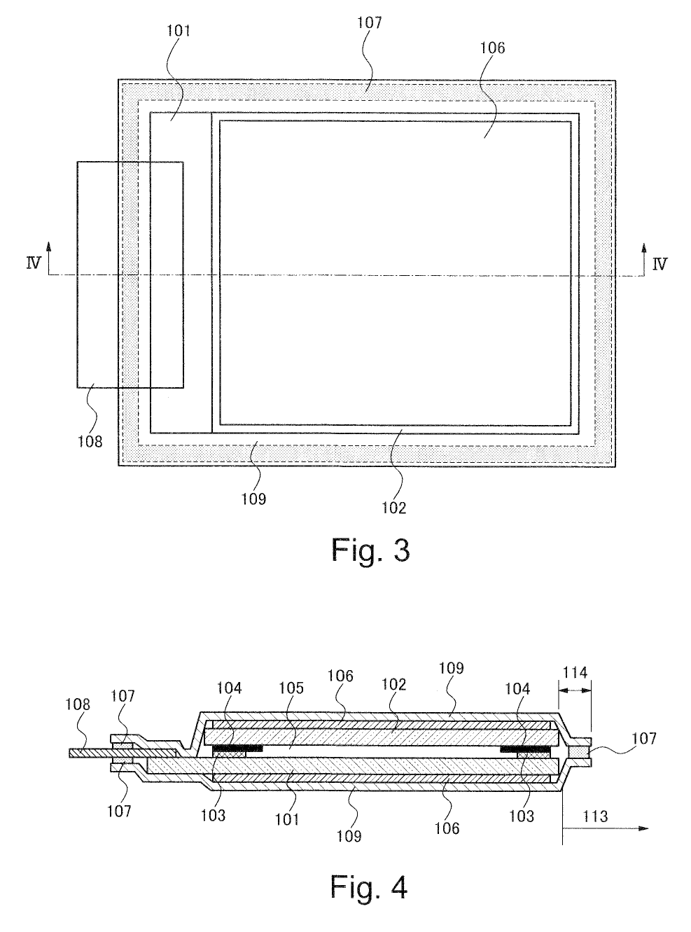

Next, an LCD device according to a second example of the present invention is explained with reference to FIG. 3 and FIG. 4. FIG. 3 is a plan view showing a structure of the LCD device of this example, and FIG. 4 is a cross-sectional view along a IV-IV line of FIG. 3.

As shown in FIG. 3 and FIG. 4, the LCD panel is formed like the first example. In this example, an optical film covering a surface of the LCD panel has a laminated structure which consists of a polarizing plate 106 and a transparent film 109 further covering an outside thereof. An adhesive layer 107 for fixing a position of the polarizing plate 106 and the LCD panel is formed in a peripheral edge part 114 of the transparent film 109 which corresponds to an outer peripheral part 113 of a TFT substrate 101 as seen from a normal direction to the display surface. The polarizing plate 106 is not formed in the overlapping region where the adhesive layer 107 is arranged. Moreover, the TFT substrate 101 and the counter substrate 102 are not directly stuck on the transparent film 109.

That is, the transparent film 109 is formed as its outline dimension is larger than that of the polarizing plate 106, and the adhesive layer 107 is arranged in the region where only the transparent film 109 is formed as seen from a normal direction to the display surface of the LCD panel.

It is desirable that a material of the transparent film 109 is a thermoplastic material which is excellent in a transmittance for visible light and a near ultraviolet ray and in a gas barrier property. For example, a PET, a PEN, or one of those materials with a surface treatment can be used. If a material excellent in a transmittance for visible light and a near ultraviolet ray is used as the transparent film 109 and an acrylic photo-curing material is used as the adhesive layer 107, a hardening reaction can be efficiently performed by means of radiating the light from a front surface of the panel.

Also in this example, it is possible to manufacture the LCD device using the same manufacturing process as the first example.

In this example, because the region in which the adhesive layer 107 is formed is covered with only the transparent film 109, the photo-curing material can be used as the material of the adhesive layer 107. Therefore, an advantage that heat stress does not arise is obtained.

The polarizing plate 106 and the transparent film 109 do not necessarily need to be adhered. If those are not adhered, in reworking the polarizing plate, the polarizing plate 106 is recyclable because only the transparent film 109 is removed and may be exchanged.

Next, in order to confirm the advantageous effect of this example, a relation between a glass substrate thickness T and a break in the substrate or gap unevenness in reworking the polarizing plate is investigated. The results are shown in Table 1. In the related art, two kinds of polarizing plates are used, whose adhesive strength S in an adhesive layer is about 2000 g/20 mm, and about 600 g/20 mm, respectively.

TABLE 1

| | EXAMPLE 2 | | RELATED ART | | | | |
|---|---|---|---|---|---|---|---|
| | S ≈ 0 g/20 mm | | S ≈ 600 g/20 mm | | S ≈ 2000 g/20 mm | | |
| | | gap | | gap | | gap | |
| T [mm] | break | unevenness | break | unevenness | break | unevenness | L [g/20 mm] |
| t0.5 | ◯ | ◯ | ◯ | ◯ | ◯ | ◯ | 7100 |
| t0.4 | ◯ | ◯ | ◯ | ◯ | ◯ | Δ | 5500 |
| t0.3 | ◯ | ◯ | ◯ | Δ | Δ | X | 3500 |
| t0.2 | ◯ | ◯ | Δ | X | X | X | 1900 |
| t0.1 | ◯ | ◯ | X | X | X | X | 500 |

◯: not happen
Δ: happen
X: frequency (NG)

Table 1 shows that in a related art, in the polarizing plate whose adhesive strength S in an adhesive layer is about 2000 g/20 mm, the panels with the glass thickness not more than t0.4 mm are likely to have gap unevenness, and also the panels with the glass thickness not more than t0.3 mm are likely to have breaks. And it is found that in the polarizing plate whose adhesive strength S in an adhesive layer is about 600 g/20 mm, the panels with the glass thickness not more than t0.3 mm are likely to have gap unevenness, and also the panels with the glass thickness not more than t0.2 mm are likely to have breaks.

On the other hand, in the structure of this example, gap unevenness or a break in the substrate does not happen even in the panels with the glass thickness not more than t0.3 mm. In particular, even in the substrate with the t0.1 mm glass thickness in which a break happens under the load L of about 500 g/20 mm on average, it is found that that gap unevenness or a break in the substrate does not happen.

Because the polarizing plate and the glass substrate are not directly adhered in the structure of this example, the stress to the substrate corresponding to “P” in Equation (1) and Equation (2) is extremely small in any panel size (corresponding to “a” in Equation (1) and Equation (2)), and in any glass thickness (corresponding to “d” in Equation (1) and Equation (2)). Therefore, the panel bending stress in reworking the polarizing plate can be extremely reduced, and the optical display device which does not have trouble such as gap unevenness or a break in the substrate can be obtained.

### THIRD EXAMPLE

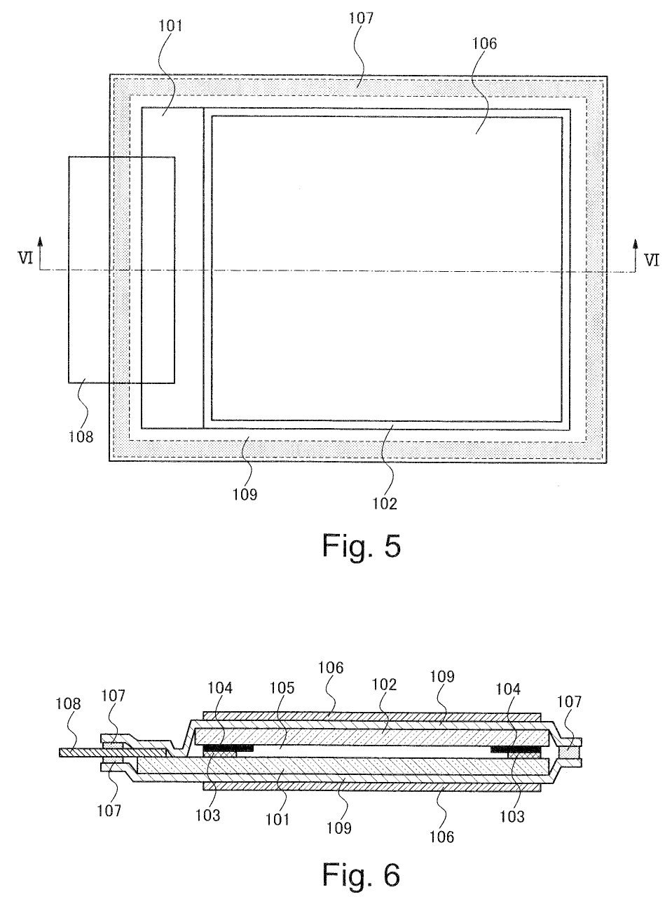

Next, an LCD device according to a third example of the present invention is described with reference to FIG. 5 and FIG. 6. FIG. 5 is a plan view showing a structure of an LCD device of this example, and FIG. 6 is a cross-sectional view along a VI-VI line of FIG. 5.

As shown in FIG. 5 and FIG. 6, in this example, an optical film covering a panel surface has a laminated structure which consists of a transparent film 109 and a polarizing plate 106 which is arranged at the outside of the transparent film 109. The polarizing plate 106 is not sealed between the LCD panel surface and the transparent film 109.

According to this example, since a polarizing plate which is generally used and has an adhesive layer on the whole surface can be used, the polarizing plate 106 can be formed by sticking on the outside of the transparent film 109 as well as generally used polarizing plates.

There is no air gap between each display-area part on the TFT substrate 101 or the counter substrate 102 and the transparent film 109 covering each of substrate surfaces, and they are closely stuck.

In this example, since the polarizing plate 106 is arranged on the outside of transparent film 109, it is possible for the polarizing plate to be reworked by removing the transparent film 109. Therefore, the advantageous effect that gap unevenness or a break in the substrate does not happen in reworking the polarizing plate is obtained. Moreover, a common polarizing plate can be used as it is.

As to forming a polarizing plate 106, following both processes are available. That is, only transparent film 109 is first stuck on the LCD panel and then the polarizing plate 106 is stuck on them, otherwise the polarizing plate 106 is beforehand stuck on the transparent film 109 and then they are stuck on the LCD panel.

Although in each above-mentioned example, the polarizing plate 106 or both of the polarizing plate 106 and the transparent film 109 are arranged on the front and back surfaces of the LCD panel, the present invention is not limited to them, the polarizing plate 106 or both of the polarizing plate 106 and the transparent film 109 can be arranged on at least one surface of the LCD panel. In these structures, the advantageous effect of the present invention is also obtained.

The present invention is effective for any type of modes of LCD devices such as a TN (twisted nematic) mode, a VA (vertical alignment) mode, and an IPS (in-plane-switching) mode, in preventing gap unevenness or a break in the substrate while a polarizing plate is removed from such LCD devices.

Although in each above-mentioned example, the structure of sticking the polarizing plate on the LCD panel is described, the present invention can be also applied in sticking an antireflection film, a protective film, or any other various films. In addition, the present invention can be also applied to optical display devices other than LCD devices, such as an organic EL (electroluminescence) display device with an antireflection film.

A fourth exemplary example of the invention has a structure in which a fluid substance having a refractive index almost equal to the transparent substrate is arranged between the optical film and the display area on the optical display panel.

According to the related art described in the background art, it is possible to reduce the stress added to a substrate and to suppress gap unevenness in reworking a polarizing plate to some extent by means of lowering adhesive strength of an adhesive for sticking the polarizing plate on the substrate.

However, in recent years, the further weight saving and slimming down of an LCD panel is demanded, and the LCD panel using a thinner glass substrate or a resin film is supplied. In the LCD panel formed with such a thinner substrate, the substrate is largely deformed by a weak stress in removing a polarizing plate. Then, although it is necessary to lower adhesive strength of a polarizing plate, if adhesive strength is made smaller too much, such troubles as peeling of a polarizing plate or shrinkage thereof by temperature in a reliability evaluation test, may arise. Therefore, it is difficult to lower adhesive strength greatly more than the former.

Because a mechanical strength of the panel itself is lowered in the LCD panel formed with a thinner substrate, a new trouble arises, that is, the substrate itself breaks in removing the polarizing plate at the reworking process.

The larger panel size becomes, the more remarkable it is for gap unevenness or a break in the substrate to arise.

On the other hand, the LCD device disclosed in Laid-open Japanese utility model publication No. Sho 60-054121 described in the background art has the structure in which the LCD panel and the polarizing plate are stuck with the adhesive member of framed shape. In such a structure, the adhesive strength between the polarizing plate and the substrate becomes smaller, and the stress in reworking the polarizing plate can be reduced. However, in this structure, because an air gap is generated between the polarizing plate and the substrate, reflection or refraction of light arises in the interface between the air gap and the substrate or the polarizing plate, therefore the contrast in the display falls off.

An exemplary advantage according to the invention is that the display-area part is prevented from deforming by the stress in removing the polarizing plate, and stress can be prevented from being added to the spherical spacer, the columnar spacer, etc. which supports the liquid crystal cell gap. Thereby, the gap unevenness, caused by the migration of the spherical spacer or caused by the plastic deformation such as crushing of the spherical spacer or the columnar spacer, can be prevented.

And another exemplary advantage according to the invention is that the stress in removing the polarizing plate can be prevented from being directly added to the TFT substrate or the counter substrate. Thereby, the break in the substrate caused by removing the polarizing plate can be reduced.

While the invention has been particularly shown and described with reference to exemplary examples thereof, the invention is not limited to these examples. It will be understood by those of ordinary skill in the art that various changes in form and details may be made therein without departing from the spirit and scope of the present invention as defined by the claims.

Further, it is the inventor's intention to retain all equivalents of the claimed invention even if the claims are amended during prosecution.

What is claimed is:

1. An optical display device, comprising:
an optical display panel;
an optical film arranged on at least one side of a surface of said optical display panel so as to be covered therewith; and
an adhesive layer for fixing said optical film on said optical display panel such that said adhesive layer is arranged outside a transparent substrate of said optical display panel as seen from a normal direction to a display surface of said optical display panel.

2. The optical display device according to claim 1, wherein a fluid substance having a refractive index almost equal to said transparent substrate is arranged between said optical film and said display area on said optical display panel.

3. The optical display device according to claim 1, wherein said optical film is a polarizing plate.

4. The optical display device according to claim 1, wherein said optical film includes a polarizing plate and a transparent film with a larger outline dimension than that of said polarizing plate, and said adhesive layer is arranged in a part with said transparent film formed alone as seen from a normal direction of a display surface to said optical display panel.

5. The optical display device according to claim 4, wherein said polarizing plate is arranged between said transparent film and said optical display panel.

6. The optical display device according to claim 4, wherein said transparent film is arranged between said polarizing plate and said optical display panel.

7. The optical display device according to claim 1, wherein said adhesive layer includes a thermoplastic material.

8. The optical display device according to claim 1, wherein said adhesive layer includes a material having a photo-curing component.

9. The optical display device according to claim 1, wherein said optical display panel is a liquid crystal panel including a TFT substrate, a counter substrate, a liquid crystal material and spacers inserted between said TFT substrate and said counter substrate, and a sealant provided to seal said liquid crystal material between said TFT substrate and said counter substrate.

10. The optical display device according to claim 9, wherein a thickness of at least one of said TFT substrate and said counter substrate is 0.3 mm or less.

11. A process of manufacturing an optical display device, comprising:
forming an optical display panel having a display area on a transparent substrate;
arranging an optical film so that said optical display panel is covered with said optical film;
arranging an adhesive layer on said optical film outside of said transparent substrate as seen from a normal direction to a display surface of said optical display panel; and
sticking said optical film on said optical display panel by using said adhesive layer so that entire outside surface of said display area is closely adhered without mixing a gas layer therebetween.
